(19) United States
(12) Patent Application Publication
(10) Pub. No.: US 2026/0089533 A1
(43) Pub. Date: Mar. 26, 2026

(54) MEASUREMENT OF WIRELESS SIGNALS

(71) Applicant: QUALCOMM Incorporated, San Diego, CA (US)

(72) Inventors: Fang YUAN, Beijing (CN); Yan ZHOU, San Diego, CA (US); Changhwan PARK, San Diego, CA (US)

(21) Appl. No.: 19/112,235

(22) PCT Filed: Nov. 24, 2022
(86) PCT No.: PCT/CN2022/134034

§ 371 Date: Mar. 14, 2025

(51) Int. Cl. H04W 24/10; H04B 7/06; H04W 36/00; H04W 72/23

(52) U.S. Cl. CPC H04W 24/10; H04B 7/0626; H04W 36/0072; H04W 72/23

(57) ABSTRACT

Aspects of the disclosure are directed to dynamic measurement for L1 and L2 mobility. In certain aspects, a user equipment (UE) is configured to obtain, from a first network node, one or more parameters, wherein the first network node forms at least a portion of a serving cell to the apparatus. The UE may measure a wireless signal originated from a second network node, the measurement being based on the one or more parameters, wherein the second network node forms at least a portion of a first candidate serving cell to the apparatus.

### BACKGROUND

### Technical Field

The present disclosure generally relates to communication systems, and more particularly, to dynamic measurement options for user equipment (UE) mobility.

### Introduction

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

Certain aspects are directed to an apparatus configured for wireless communication, comprising a memory comprising instructions and one or more processors configured to execute the instructions. In some examples, the one or more processors are configured to cause the apparatus to obtain, from a first network node, one or more parameters, wherein the first network node forms at least a portion of a serving cell to the apparatus. In some examples, the one or more processors are configured to cause the apparatus to measure a wireless signal originated from a second network node, the measurement being based on the one or more parameters, wherein the second network node forms at least a portion of a first candidate serving cell to the apparatus. In some examples, the one or more processors are configured to cause the apparatus to output, for transmission to the first network node, a measurement report based on the measurement of the wireless signal.

Certain aspects are directed to a method for wireless communication at an apparatus. In some examples, the method includes obtaining, from a first network node, one or more parameters, wherein the first network node forms at least a portion of a serving cell to the apparatus. In some examples, the method includes measuring a wireless signal originated from a second network node, the measurement being based on the one or more parameters, wherein the second network node forms at least a portion of a first candidate serving cell to the apparatus. In some examples, the method includes outputting, for transmission to the first network node, a measurement report based on the measurement of the wireless signal.

Certain aspects are directed to an apparatus for wireless communication. In some examples, the apparatus includes means for obtaining, from a first network node, one or more parameters, wherein the first network node forms at least a portion of a serving cell to the apparatus. In some examples, the apparatus includes means for measuring a wireless signal originated from a second network node, the measurement being based on the one or more parameters, wherein the second network node forms at least a portion of a first candidate serving cell to the apparatus. In some examples, the apparatus includes means for outputting, for transmission to the first network node, a measurement report based on the measurement of the wireless signal.

Certain aspects are directed to a non-transitory computer-readable medium comprising instructions that, when executed by an apparatus, cause the apparatus to perform operations. In some examples, the operations include obtaining, from a first network node, one or more parameters, wherein the first network node forms at least a portion of a serving cell to the apparatus. In some examples, the operations include measuring a wireless signal originated from a second network node, the measurement being based on the one or more parameters, wherein the second network node forms at least a portion of a first candidate serving cell to the apparatus. In some examples, the operations include outputting, for transmission to the first network node, a measurement report based on the measurement of the wireless signal.

Certain aspects are directed to an apparatus configured for wireless communication comprising a memory comprising instructions and one or more processors configured to execute the instructions. In some examples, the one or more processors are configured to cause the apparatus to output, for transmission to a user equipment (UE), one or more parameters associated with a measurement performed by the UE on a wireless signal originated from a network node, wherein the apparatus forms at least a portion of a serving cell to the UE, and wherein the network node forms at least a portion of a first candidate serving cell to the UE. In some examples, the one or more processors are configured to cause the apparatus to obtain, from the UE, a measurement report based on the measurement of the wireless signal, wherein the measurement is based on the one or more parameters.

Certain aspects are directed to a method for wireless communication at an apparatus. In some examples, the method includes outputting, for transmission to a user equipment (UE), one or more parameters associated with a measurement performed by the UE on a wireless signal originated from a network node, wherein the apparatus forms at least a portion of a serving cell to the UE, and wherein the network node forms at least a portion of a first candidate serving cell to the UE. In some examples, the method includes obtaining, from the UE, a measurement report based on the measurement of the wireless signal, wherein the measurement is based on the one or more parameters.

Certain aspects are directed to an apparatus for wireless communication. In some examples, the apparatus includes means for outputting, for transmission to a user equipment (UE), one or more parameters associated with a measurement performed by the UE on a wireless signal originated from a network node, wherein the apparatus forms at least a portion of a serving cell to the UE, and wherein the network node forms at least a portion of a first candidate serving cell to the UE. In some examples, the apparatus includes means for obtaining, from the UE, a measurement report based on the measurement of the wireless signal, wherein the measurement is based on the one or more parameters.

Certain aspects are directed to a non-transitory computer-readable medium comprising instructions that, when executed by an apparatus, cause the apparatus to perform operations. In some examples, the operations include outputting, for transmission to a user equipment (UE), one or more parameters associated with a measurement performed by the UE on a wireless signal originated from a network node, wherein the apparatus forms at least a portion of a serving cell to the UE, and wherein the network node forms at least a portion of a first candidate serving cell to the UE. In some examples, the operations include obtaining, from the UE, a measurement report based on the measurement of the wireless signal, wherein the measurement is based on the one or more parameters.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and user equipment (UE) in an access network.

FIG. 4 is a block diagram illustrating an example disaggregated base station architecture.

FIG. 5 is a block diagram illustrating an example network.

FIG. 6 is a block diagram illustrating example L1 measurements.

FIG. 7 is a flowchart 700 of a method of wireless communication.

FIG. 8 is a diagram illustrating an example of a hardware implementation for an example apparatus.

FIG. 9 is a flowchart of a method of wireless communication.

FIG. 10 is a diagram illustrating another example of a hardware implementation for another example apparatus.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

3rd Generation Partnership Project (3GPP) mobile telecommunications standards may support dynamic (e.g., event-triggered and/or periodic) layer-1 (L1) and/or layer-2 (L2) measuring and reporting. However, such measuring may require a significant amount of power from the perspective of a user equipment (UE), especially considering that layer-3 (L3) measuring and reporting may occur concurrently. Such dynamic measurements may also be highly complex. Thus, aspects of the disclosure are directed to dynamic measurement options for the UE and network to reduce power consumption of the UE and reduce complexity of such operations.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

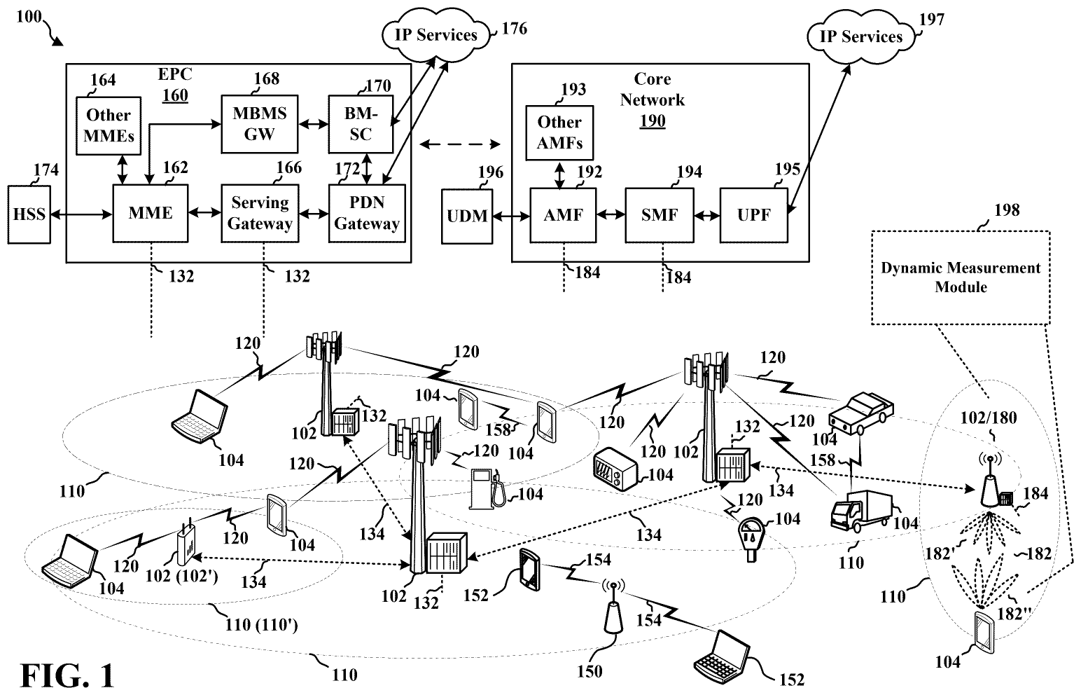

FIG. 1 is a diagram illustrating an example of a wireless communications system and an access network 100. The wireless communications system (also referred to as a wireless wide area network (WWAN)) includes base stations 102, user equipment(s) (UE) 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells. The base stations 102 configured for 4G Long Term Evolution (LTE) (collectively referred to as Evolved Universal Mobile Telecommunications System (UMTS) Terrestrial Radio Access Network (E-UTRAN)) may interface with the EPC 160 through first backhaul links 132 (e.g., S1 interface). The base stations 102 configured for 5G New Radio (NR) (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, Multimedia Broadcast Multicast Service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y megahertz (MHz) (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154, e.g., in a 5 gigahertz (GHz) unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHz, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). The frequencies between FR1 and FR2 are often referred to as mid-band frequencies. Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, or may be within the EHF band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHz spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, an MBMS Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides Quality of Service (QOS) flow and session management. All user IP packets are transferred through the UPF 195. The UPF 195 provides UE IP address allocation as well as other functions. The UPF 195 is connected to the IP Services 197. The IP Services 197 may include the Internet, an intranet, an IMS, a Packet Switch (PS) Streaming Service, and/or other IP services.

The base station may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Referring again to FIG. 1, in certain aspects, the UE 104 may be configured with a dynamic measurement module 198 configured to obtain, from a first network node, one or more parameters associated with measuring a wireless signal originated from a second network node, wherein the first network node forms at least a portion of a serving cell to the apparatus; measure a wireless signal originated from a second network node, the measurement being based on the one or more parameters, wherein the second network node forms at least a portion of a first candidate serving cell to the apparatus; and output, for transmission to the first network node, a measurement report based on the measurement of the wireless signal.

Referring again to FIG. 1, in certain aspects, the base station 180 may be configured with the dynamic measurement module 198 configured to output, for transmission to a user equipment (UE), one or more parameters associated with a measurement performed by the UE on a wireless signal originated from a network node, wherein the apparatus forms at least a portion of a serving cell to the UE, and wherein the network node forms at least a portion of a first candidate serving cell to the UE; and obtain, from the UE, a measurement report based on the measurement of the wireless signal, wherein the measurement is based on the one or more parameters.

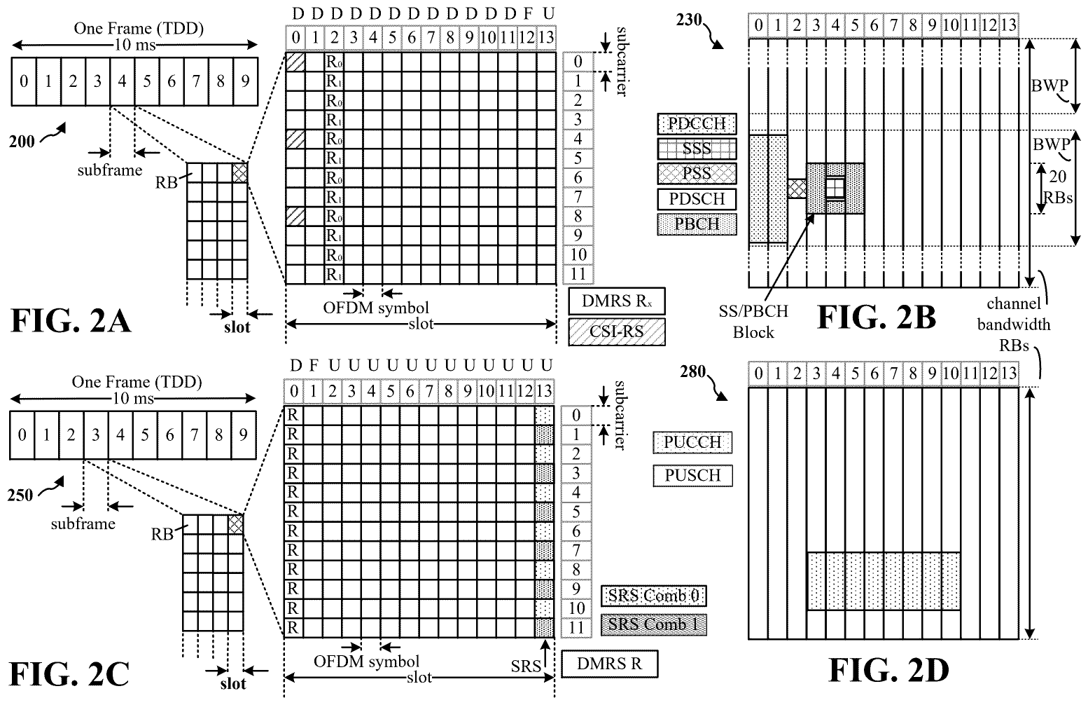

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

Other wireless communication technologies may have a different frame structure and/or different channels. A frame, e.g., of 10 milliseconds (ms), may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on DL may be cyclic prefix (CP) orthogonal frequency-division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies μ 0 to 4 allow for 1, 2, 4, 8, and 16 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2^{μ} slots/subframe. The subcarrier spacing and symbol length/duration are a function of the numerology. The subcarrier spacing may be equal to 2^{μ}* 15 kilohertz (kHz), where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as Rx for one particular configuration, where 100× is the port number, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol. A PDCCH within one BWP may be referred to as a control resource set (CORESET). Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgement (ACK)/non-acknowledgement (NACK) feedback. The PUSCH carries data, and may additionally be used to carry a buffer status report (BSR), a power headroom report (PHR), and/or UCI.

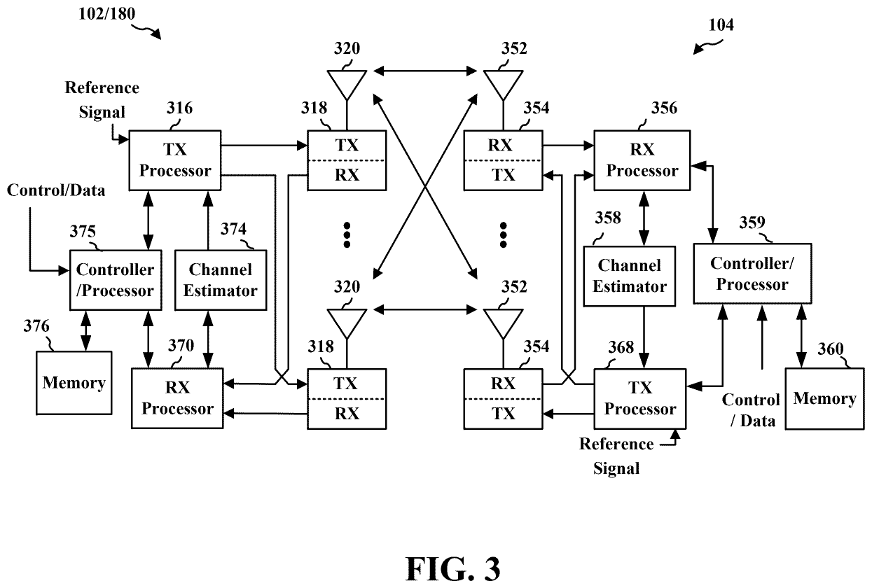

FIG. 3 is a block diagram of a base station 102/180 in communication with a UE 104 in an access network. In the DL, IP packets from the EPC 160 may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 104. Each spatial stream may then be provided to a different antenna 320 via a separate transmitter 318TX. Each transmitter 318TX may modulate an RF carrier with a respective spatial stream for transmission.

At the UE 104, each receiver 354RX receives a signal through its respective antenna 352. Each receiver 354RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 104. If multiple spatial streams are destined for the UE 104, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 102/180. These soft decisions may be based on channel estimates computed by the channel estimator 358. The soft decisions are then decoded and deinterleaved to recover the data and control signals that were originally transmitted by the base station 102/180 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the DL transmission by the base station 102/180, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 102/180 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the base station 102/180 in a manner similar to that described in connection with the receiver function at the UE 104. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 104. IP packets from the controller/processor 375 may be provided to the EPC 160. The controller/processor 375 is also responsible for error detection using an ACK and/or NACK protocol to support HARQ operations.

At least one of the TX processor 368, the RX processor 356, and the controller/processor 359 may be configured to perform aspects in connection with 198 of FIG. 1.

At least one of the TX processor 316, the RX processor 370, and the controller/processor 375 may be configured to perform aspects in connection with 198 of FIG. 1.

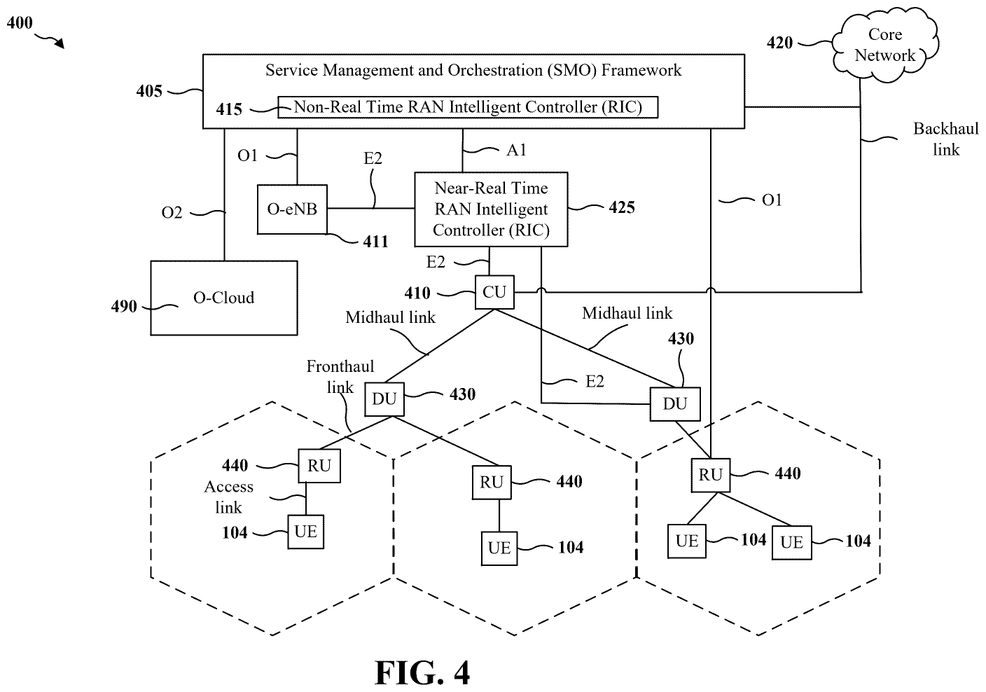

FIG. 4 is a block diagram illustrating an example disaggregated base station 400 architecture. The disaggregated base station 400 architecture may include one or more CUs 410 that can communicate directly with a core network 420 via a backhaul link, or indirectly with the core network 420 through one or more disaggregated base station units (such as a near real-time (RT) RIC 425 via an E2 link, or a non-RT RIC 415 associated with a service management and orchestration (SMO) Framework 405, or both). A CU 410 may communicate with one or more DUs 430 via respective midhaul links, such as an F1 interface. The DUs 430 may communicate with one or more RUs 440 via respective fronthaul links. The RUs 440 may communicate with respective UEs 104 via one or more radio frequency (RF) access links. In some implementations, the UE 104 may be simultaneously served by multiple RUs 440.

Each of the units, i.e., the CUS 410, the DUs 430, the RUs 440, as well as the near-RT RICs 425, the non-RT RICs 415 and the SMO framework 405, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 410 may host higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 410. The CU 410 may be configured to handle user plane functionality (i.e., central unit—user plane (CU-UP)), control plane functionality (i.e., central unit—control plane (CU-CP)), or a combination thereof. In some implementations, the CU 410 can be logically split into one or more CU-UP units and one or more CU-CP units. The CU-UP unit can communicate bidirectionally with the CU-CP unit via an interface, such as the E1 interface when implemented in an O-RAN configuration. The CU 410 can be implemented to communicate with the DU 430, as necessary, for network control and signaling.

The DU 430 may correspond to a logical unit that includes one or more base station functions to control the operation of one or more RUs 440. In some aspects, the DU 430 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 430 may further host one or more low PHY layers. Each layer (or module) can be implemented with an interface configured to communicate signals with other layers (and modules) hosted by the DU 430, or with the control functions hosted by the CU 410.

Lower-layer functionality can be implemented by one or more RUs 440. In some deployments, an RU 440, controlled by a DU 430, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 440 can be implemented to handle over the air (OTA) communication with one or more UEs 104. In some implementations, real-time and non-real-time aspects of control and user plane communication with the RU(s) 440 can be controlled by the corresponding DU 430. In some scenarios, this configuration can enable the DU(s) 430 and the CU 410 to be implemented in a cloud-based RAN architecture, such as a virtual RAN (vRAN) architecture.

The SMO Framework 405 may be configured to support RAN deployment and provisioning of non-virtualized and virtualized network elements. For non-virtualized network elements, the SMO framework 405 may be configured to support the deployment of dedicated physical resources for RAN coverage requirements, which may be managed via an operations and maintenance interface (such as an O1 interface). For virtualized network elements, the SMO framework 405 may be configured to interact with a cloud computing platform (such as an open cloud (O-cloud) 490) to perform network element life cycle management (such as to instantiate virtualized network elements) via a cloud computing platform interface (such as an O2 interface). Such virtualized network elements can include, but are not limited to, CUs 410, DUs 430, RUs 440 and near-RT RICs 425. In some implementations, the SMO framework 405 can communicate with a hardware aspect of a 4G RAN, such as an open eNB (O-eNB) 411, via an O1 interface. Additionally, in some implementations, the SMO Framework 405 can communicate directly with one or more RUs 440 via an O1 interface. The SMO framework 405 also may include the non-RT RIC 415 configured to support functionality of the SMO Framework 405.

The non-RT RIC 415 may be configured to include a logical function that enables non-real-time control and optimization of RAN elements and resources, artificial intelligence/machine learning (AI/ML) workflows including model training and updates, or policy-based guidance of applications/features in the near-RT RIC 425. The non-RT RIC 415 may be coupled to or communicate with (such as via an A1 interface) the near-RT RIC 425. The near-RT RIC 425 may be configured to include a logical function that enables near-real-time control and optimization of RAN elements and resources via data collection and actions over an interface (such as via an E2 interface) connecting one or more CUs 410, one or more DUs 430, or both, as well as an O-eNB, with the near-RT RIC 425.

In some implementations, to generate AI/ML models to be deployed in the near-RT RIC 425, the non-RT RIC 415 may receive parameters or external enrichment information from external servers. Such information may be utilized by the near-RT RIC 425 and may be received at the SMO Framework 405 or the non-RT RIC 415 from non-network data sources or from network functions. In some examples, the non-RT RIC 415 or the near-RT RIC 425 may be configured to tune RAN behavior or performance. For example, the non-RT RIC 415 may monitor long-term trends and patterns for performance and employ AI/ML models to perform corrective actions through the SMO Framework 405 (such as reconfiguration via O1) or via creation of RAN management policies (such as A1 policies).

Still referring to FIG. 4, a DU 430 or CU 410 may configure a set of cells that support layer 1 (L1) and layer 2 (L2) UE 104 mobility. The set of cells may include the CU 410, one or more DUs 430, and a plurality of RUs 440, wherein one or more of the plurality of RUs 440 are managed by the same DU 430. Here, the CU 410 and/or the DU 430 may configure a set of RUs 440 such that the CU 410 and the DU 430 manage each cell associated with each RU 440 (e.g., a set of cells). In this example, each cell in the set of cells includes the CU 410, the DU 430, and one of the plurality of RUs 440. For example, the CU 410, the DU 430, and a first RU may make up a first cell of the plurality of cells, the CU 410, the DU 430, and a second RU may make up a second cell of the plurality of cells. It should be noted that although FIG. 4 illustrates three RUs in the cell set, any suitable number of RUs may be used.

In this example, each cell of the set of cells support L1 and L2 communications between the plurality of RUs 440 and the UE 104, and each cell may use the same or a different carrier frequency relative to another cell. Each cell may be configured as a primary cell (PCell) or a special cell (sPCell) and may use L1/L2 signaling to update a PCell/sPCell in the set of cells. Thus, one or more of the cells in the cell set may be activated and used for data and control communications with one or more UEs via L1/L2 signaling.

As used herein, an “activated/active cell” is a cell that the UE 104 may communicate (e.g., transmit and receive wireless signals) data and control signals with. In some examples, the UE 104 may be configured to support multiple activated cells, or only a single activated cell. In the single activated cell case, the activation of a cell may be made with the assumption that another activated cell will be deactivated after a handover.

As used herein, a “deactivated cell” may relate to a cell with which the UE 104 cannot communicate data and control signals. For example, a deactivated cell may not be used for communication with the UE 104, but the deactivated cell may be activated via L1/L2 signaling and used as a PCell/sPCell once activated.

### Example Options for Dynamic Measurement of Wireless Signals

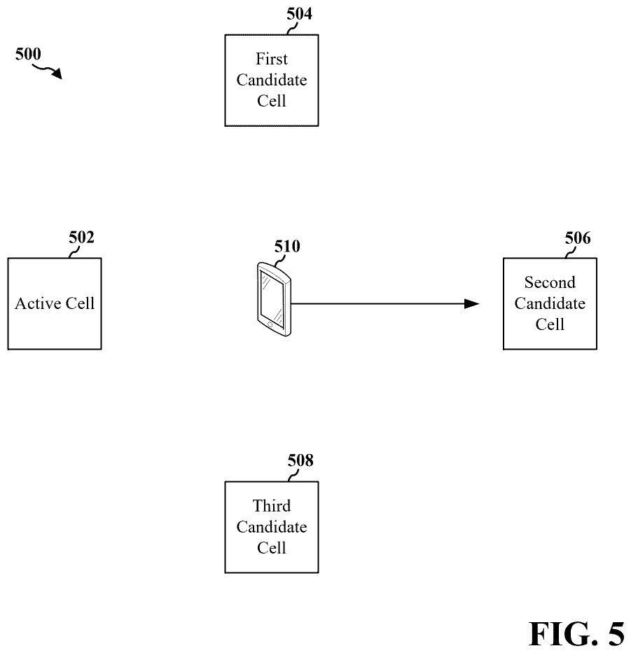

FIG. 5 is a block diagram illustrating an example network 500 including a UE 510 (e.g., UE 104 of FIGS. 1 and 3), and active cell 502, a first candidate cell 504, a second candidate cell 506, and a third candidate cell 508. Each of the cells may correspond to a network node such as those illustrated in FIG. 4 or a base station 102/180 such as those illustrated in FIGS. 1, 3, and 4. Each of the cells may be configured as a special cell (SpCell) and may be part of a pre-configured candidate SpCell set. That is, the active cell 502 may configure the UE 510 with information associated with the candidate cells. In this example, the UE 510 may be configured to switch cells based on L1 measurement. Each of the candidate cells may be a deactivated cell.

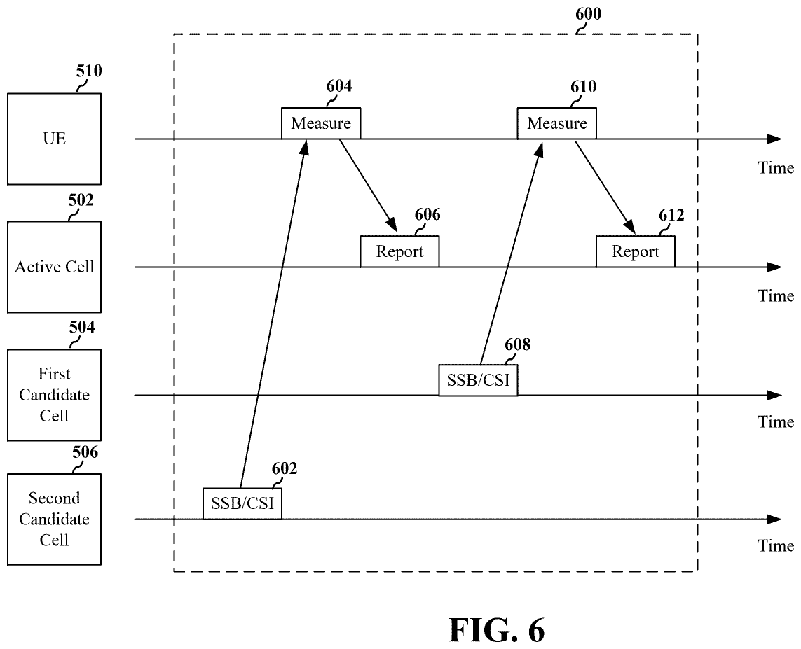

The UE 510 may have an active communication link with the active cell 502, but the UE 510 may also be mobile and moving in a direction away from the active cell 502 and closer to the second candidate cell. Thus, the active cell 502 may transmit a handover command to the UE 510 instructing the UE to drop its connection with the active cell 502 and establish a connection with the second candidate cell 506 so that the second candidate cell becomes the active cell. The handover command may be based on L1 and/or L2 signaling between the UE and the second candidate cell 506. FIG. 6 is a block diagram illustrating example L1 measurements 600 between the UE, the active cell 502, the first candidate cell 504, and the second candidate cell 506. Initially, the active cell 502 may transmit a command instructing the UE 510 to perform measurements (e.g., L1 and/or L2) on signals the UE 510 receives from one or more of the candidate cells. The command may be transmitted via a downlink control information (DCI) message, a radio resource control (RRC) message, or a medium access control-control element (MAC-CE). The first candidate cell 504 may transmit a first signal 602. The first signal may include one or more of a synchronization signal block (SSB) and/or a channel status information (CSI) signal. The UE 510 may receive the first signal 602 and perform a first measurement 604 of the SSB and/or CSI. The UE 510 may then generate a first report 606 and transmit the first report to the active cell.

Similarly, the second candidate cell 506 may transmit a second signal 608. The second signal may include one or more of an SSB and/or a CSI signal. The UE 510 may receive the second signal 608 and perform a second measurement 610 of the SSB and/or CSI. The UE 510 may then generate a second report 612 and transmit the second report to the active cell 502. Based on the reports, the active cell 502 may determine to transmit a handover command to the UE 510 if the report indicates that a signal from one of the candidate cells meets a threshold quality.

In certain aspects, the UE 510 may be configured to perform different types of L1 measurements. For example, a first type of L1 measurement may be for downlink synchronization. Here, the UE 510 may use L1 measurements to track a synchronization signal (e.g., SSB) for a candidate cell to determine signal timing of the candidate cell (e.g., slot timing). A second type of L1 measurement may be for beam failure monitoring, wherein the UE 510 may monitor a beam quality of a candidate cell using L1 measurements. A third type of L1 measurement may be for radio link monitoring, wherein the UE 510 may monitor one or more reference signals of a candidate cell for radio link failure (RLF). A fourth type of L1 measurement may include CSI measurement for measuring the characteristics of a radio channel and determining a correct modulation, code rate, beam forming, etc. of a candidate cell and generating and transmitting an L1-CSI report to the active cell. A fifth type of L1 measurement may include tracking reference signal (TRS) monitoring so that the UE 510 may track time and frequency of a candidate cell. A sixth type of L1 measurement may include measurements for uplink timing maintenance. For example, the UE may monitor and maintain uplink transmission timing based on an L1 measurement of a downlink signal. One or more types of L1 measurements may be reported to the active cell via a different report relative to other types of L1 measurements. It should be noted that the types of L1 measurements described above are examples, and that any L1 measurement type is contemplated by this disclosure.

In certain aspects, a base station may be configured to transmit, via the active cell 502, an indication to the UE 510 instructing the UE 510 to start or suspend a particular type of L1 measurement. The indication may be transmitted by RRC, MAC-CE, or DCI. In other words, the UE 510 may receive explicit signaling to start/stop an L1 measurement, and the UE 510 may be configured to only perform L1 measurements or suspend L1 measurements based on signaling received from the active cell 502. By providing the base station with the ability to control L1 measuring by the UE 510, the base station may reduce power consumption at the UE 510 by reducing the amount of L1 measurements and/or L1 measurement reporting performed by the UE 510.

In some examples, the base station may configure the UE 510, via the active cell 502, with a threshold quality value (e.g., RSSI, RSRP, RSRQ, and/or any other suitable measure indicative of signal quality). In this example, the UE 510 may be configured to perform L1 measurements on signaling from a candidate cell if signal quality of the active cell 502 is equal to or above the threshold quality value. If the active cell 502 communication quality is above the threshold value, then the UE 510 does not perform L1 measurements because the signal quality of the active cell 502 is sufficient for the UE's needs. Thus, the UE 510 may ignore a scheduled L1 measurement and/or an L1 measurement command from the active cell 502 if the active cell quality is above the threshold value. Similarly, the UE 510 may be triggered to begin L1 measurements of signaling from candidate cells if the signal quality of the active cell is measured below the threshold value. Thus, if the signal quality of the active cell 502 is equal to or above the threshold value, then the UE 510 may not consume power resources performing L1 measurements and/or transmission of L1 reports. It should be noted that a threshold value may be cell-specific for each active cell. Accordingly, the active cell may configure the UE with the threshold value.

In some examples, the base station may configure the UE 510 with one or more timer durations and events that trigger the activation of a timer for starting or suspending L1 measurements by the UE 510. Here, the active cell 502 may configure the UE 510 with a timer duration and an indication of when the timer is activated. For example, the UE 510 may be triggered to start a timer when the UE performs a first L1 measurement 604. For the duration of the timer, the UE 510 may suspend L1 measurements and/or L1 measurement reporting. For example, for the duration of the timer, the UE 510 may perform no L1 measurements on signals received from candidate cells. Expiration of the timer may trigger the UE 510 to perform a second L1 measurement 610 and restart the timer.

It should be noted that the base station may configure the UE 510 so that any event may trigger activation of the timer. For example, the UE 510 may start the timer after transmitting an L1 measurement report to the active cell 502, and if the timer is running, UE 510 may not perform any L1 measurements and/or report such measurements. Thus, if the timer is not running, the UE may suspend or start L1 measurements and/or L1 measurement reporting.

The active cell 502 may configure the UE to perform L1 measurements and/or transmit L1 measurement reports based on an event trigger. Such a triggering event may include a periodic scheduling, a semi-persistent scheduling, and/or an event such as those described above. In one example, the UE 510 may perform an L1 measurement on a signal received from the first candidate cell 504. If the measurement indicates that the quality of the measured signal is equal to or above a threshold value (e.g., configured by the active cell 502), then the satisfaction of the threshold condition may trigger the UE 510 to generate and transmit the L1 measurement in a report to the active cell 502. If the measurement indicates that the quality of the signal is below the threshold value, then the UE 510 may refrain from transmitting the report.

In some examples, if L1 measurements are suspended at the UE 510, then no corresponding event or schedule may trigger the UE 510 to perform an L1 measurement or transmit an L1 measurement report. In other words, the UE 510 may not be required to perform any L1 measurement and/or report any L1 measurement regardless of a triggering event.

In certain aspects, the UE 510 may provide the base station, in an L1 measurement report, with an indication of which L1 measurement was performed, which report configuration was transmitted, which candidate cell(s) transmitted the signaling that upon which the L1 measurement was performed, and/or which candidate cell should be active for communication with the UE 510. Here, the UE 510 may determine which L1 measurement to perform (e.g., whether the UE 510 performs L1 measurement of SS-RSRP and/or CSI-RSRP of the candidate cell, or whether the UE 510 performs a particular type of L1 measurement). The UE 510 may also determine which candidate cells to measure and report, and determine the configuration of the report. Thus, the UE 510 may reduce its own L1 measurement operations based on its available power in order to extend the life of the UE 510.

In some examples, the UE 510 may explicitly identify the which L1 measurement, L1 measurement report configuration, and/or the subject candidate cell(s) in the L1 measurement report. As such, the UE 510 may include information in the report that identifies the candidate cells for which the L1 measurement report corresponds to. If the UE 510 measures a signal from the second candidate cell 506, then the UE may include information identifying the second candidate cell in a report comprising the measurement of the signal. The report may also include the type of L1 measurement performed, and/or the type or configuration of the report being transmitted to the active cell 502.

In some examples, the base station may configure the UE 510 to perform an L1 measurement and/or transmit an L1 measurement report to the active cell 502 only if an L3 measurement performed by the UE 510 on a candidate cell satisfies a threshold value. In such an example, the base station may be implicitly informed that any L1 measurement report corresponds to a candidate cell that has a relatively high quality L3 measurement. Similarly, satisfaction of an L3 measurement threshold condition may trigger a particular type of L1 measurement and/or report configuration of the measurement, thereby implicitly informing the base station of the L3 measurement.

In some examples, the base station may indicate, via the active cell 502, to the UE 510 which L1 measurement, which measurement report configuration, and/or which candidate cell(s) may be used by the UE 510. For example, the base station may configure the UE 510 to perform a particular one or more L1 measurement(s) on a particular one or more cell(s), and/or indicate which report should be used for communication of the one or more measurements. Thus, in an example with multiple candidate cells and multiple different L1 measurements, the UE 510 may be configured to perform different L1 measurements for different candidate cells, and communicate different reports to the active cell 502 for the different measurements.

In some examples, UE 510 may be configured to perform all L1 measurements that the UE 510 is capable of using, and using all measurement reports for all candidate cells.

In certain aspects, for event triggered L1/L2 based mobility for a candidate cell, the UE 510 may be configured by the base station with events that trigger the UE 510 to transmit an L1 measurement report. In one example, an event which triggers the start or suspension of transmitting a measurement report may be indicated by the base station to the UE 510 via the active cell 502. The indication may be transmitted to the UE 510 via RRC, MAC-CE, or DCI. For example, the triggering event may be based on whether signaling from the active cell 502 meets a threshold quality condition, as described above in reference to L1 measurements. Here, the UE 510 may not be required to transmit an L1 measurement report based on signals of candidate cell(s) if the active cell 502 quality is above the threshold value. In some examples, the triggering event may be based on a timer to start or suspend transmission of an L1 measurement report, as described above in reference to L1 measurements. Thus, if the timer is not running, the UE may suspend or start transmission of an L1 measurement report.

In certain aspects, the base station may configure the UE for L1, L2, and/or L3 mobility options. The base station may configure the UE such that only L1/L2 or L3 based mobility configurations can be configured or enabled at a time. In one example, both L1/L2 and L3 can be configured at the UE 510, but only one of L1/L2 or L3 can be active. That is, the UE 510 may only use one of the mobility options at a time (e.g., activation of L1/L2 mobility functions will deactivate L3 mobility functions, and activation of L3 mobility functions will deactivate L1/L2 mobility functions). In another example, the base station may configure the UE 510 with only one of the L1/L2 or L3 mobility options such that the UE 510 has the capability of performing only L1/L2 or L3.

In some examples, the UE 510 may be configured with both L1/L2 and L3 based mobility configurations and both configuration may be enabled simultaneously. In one example, the base station may transmit a first handover command. The first handover command may be configured to be executed after an event (e.g., X ms after receipt of the command or after UE 510 transmits ACK to the active cell 502). However, the base station may transmit a second handover command to the UE 510 which is received prior to execution of the first handover command. In such an example, the UE 510 may be configured by the base station to execute the latest handover command received in time. Thus, if the first handover command is an L3 handover command, and the second handover command is an L1/L2 handover command, then the L1/L2 handover command may be executed by the UE 510 instead of the L3.

In another example, the UE 510 may be configured by the base station to prioritize a particular type of handover command. In this example, if the UE is configured to prioritize L3 handover commands over L1/L2 handover commands, then the UE 510 may execute the first handover command and ignore the second handover command.

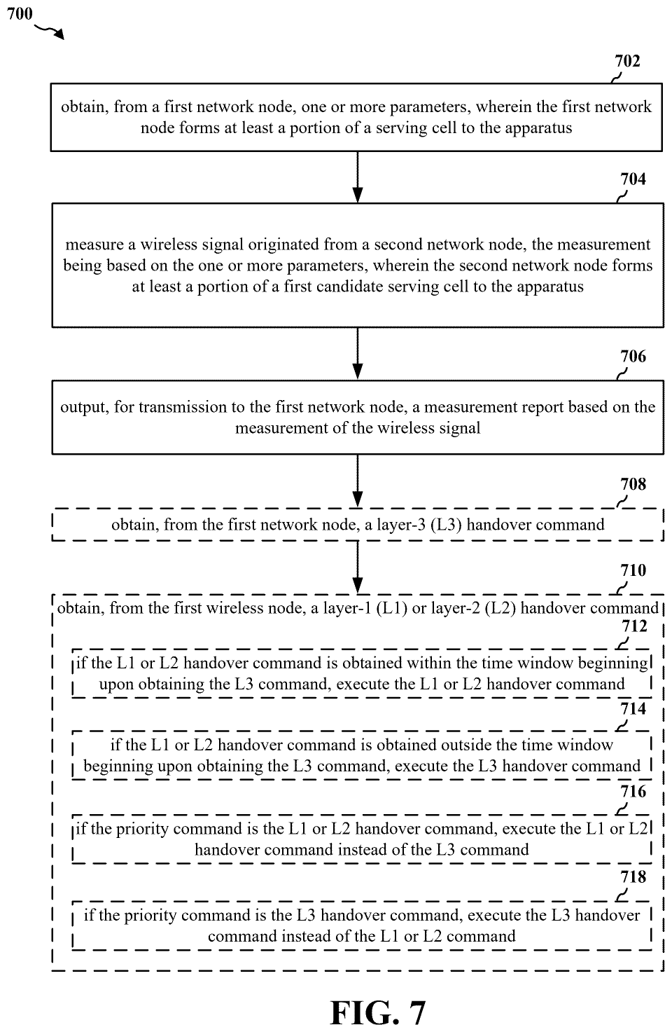

FIG. 7 is a flowchart 700 of a method of wireless communication. The method may be performed by a UE (e.g., the UE 104; the apparatus 802).

At 702, the UE may obtain, from a first network node, one or more parameters, wherein the first network node forms at least a portion of a serving cell to the apparatus. For example, 702 may be performed by an obtaining component 840.

At 704, the UE may measure a wireless signal originated from a second network node, the measurement being based on the one or more parameters, wherein the second network node forms at least a portion of a first candidate serving cell to the apparatus. For example, 704 may be performed by a measuring component 842.

At 706, the UE may output, for transmission to the first network node, a measurement report based on the measurement of the wireless signal. For example, 706 may be performed by an outputting component 844.

At 708, the UE may optionally obtain, from the first network node, a layer-3 (L3) handover command. For example, 708 may be performed by the obtaining component 840.

At 710, the UE may optionally obtain, from the first wireless node, a layer-1 (L1) or layer-2 (L2) handover command. For example, 710 may be performed by the obtaining component 840.

At 712, the UE may optionally, if the L1 or L2 handover command is obtained within the time window beginning upon obtaining the L3 command, execute the L1 or L2 handover command. For example, 712 may be performed by the executing component 846.

At 714, the UE may optionally, if the L1 or L2 handover command is obtained outside the time window beginning upon obtaining the L3 command, execute the L3 handover command. For example, 714 may be performed by the executing component 846.

At 716, the UE may optionally, if the priority command is the L1 or L2 handover command, execute the L1 or L2 handover command instead of the L3 command. For example, 716 may be performed by the executing component 846.

At 718, the UE may optionally, if the priority command is the L3 handover command, execute the L3 handover command instead of the L1 or L2 command. For example, 718 may be performed by the executing component 846.

In certain aspects, the one or more parameters are obtained via at least one of a radio resource control (RRC) message, a medium access-control control element (MAC-CE), or a downlink control information (DCI) message.

In certain aspects, the measurement is a layer-1 (L1) measurement or a layer-2 (L2) measurement, and wherein the one or more parameters comprise an indication to start or suspend the L1 or L2 measurement.

In certain aspects, the one or more parameters further comprise a threshold signal quality value and an indication to: start the L1 measurement or L2 measurement if signaling obtained from the first network node is less than the threshold signal quality value; and suspend the L1 measurement or L2 measurement if signaling obtained from the first network node is greater than the threshold signal quality value.

In certain aspects, the one or more parameters further comprise an indication to: start the L1 measurement or L2 measurement if a timer expires prior to obtaining a handover command from the first network node, the timer configured to begin upon output of the measurement report; and suspend the L1 measurement or L2 measurement if the apparatus obtains the handover command from the first network node prior to expiration of the timer.

In certain aspects, the one or more parameters further comprise a duration of the timer.

In certain aspects, the one or more parameters comprise an indication to start or suspend the L1 measurement or L2 measurement according to a periodic schedule.

In certain aspects, the one or more parameters comprise an indication of a type of measurement of the wireless signal originated from the second network node, and wherein the type of measurement comprises downlink synchronization, beam failure monitoring, radio link monitoring, channel state indication (CSI) measurement, tracking reference signal (TRS) measurement, or uplink timing measurement.

In certain aspects, the measurement report comprises an indication of: one or more types of measurement; or the first candidate serving cell for which the measurement is performed.

In certain aspects, the one or more parameters comprise an indication of one or more candidate serving cells for which a measurement report is to be generated based on a corresponding wireless signal, the one or more candidate serving cells including the first candidate serving cell.

In certain aspects, the measurement is a layer-1 (L1) measurement, a layer-2 (L2) measurement, or a layer-3 (L3) measurement, and wherein the one or more parameters comprise an indication of whether one or more of the L1 measurement, the L2 measurement, and the L3 measurement are activated at the apparatus.

In certain aspects, an activation of the L1 measurement or L2 measurement deactivates the L3 measurement, and wherein an activation of the L3 measurement deactivates the L1 measurement or the L2 measurement.

In certain aspects, the one or more measurement parameters comprise an indication of a time window.

In certain aspects, the one or more parameters comprise an indication of a priority command.

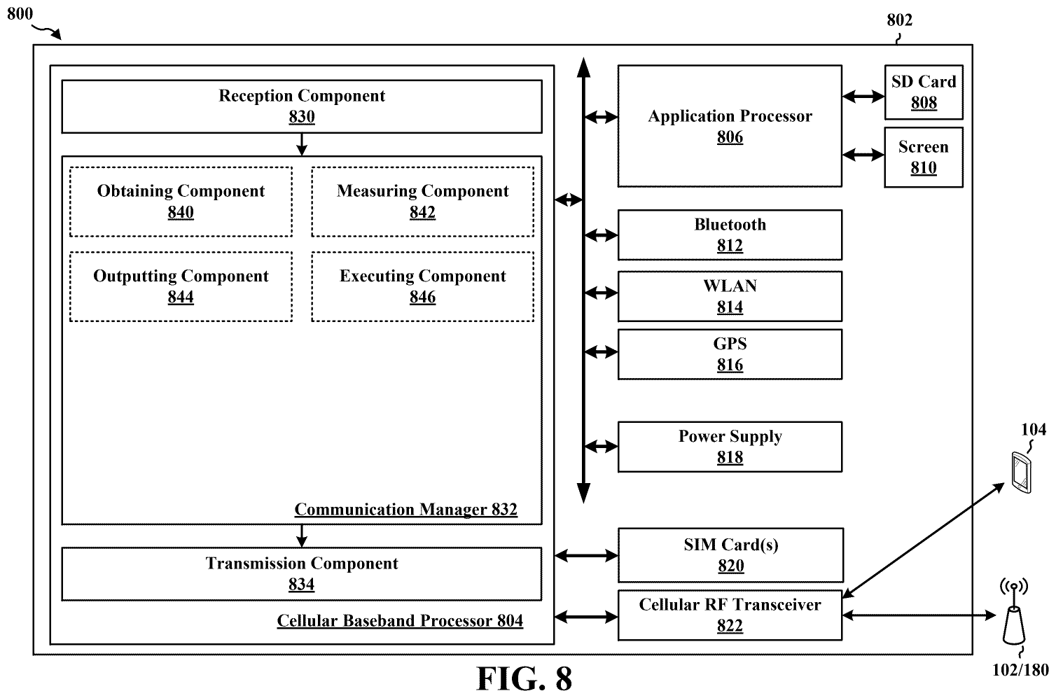

FIG. 8 is a diagram 800 illustrating an example of a hardware implementation for an apparatus 802. The apparatus 802 is a UE and includes a cellular baseband processor 804 (also referred to as a modem) coupled to a cellular RF transceiver 822 and one or more subscriber identity modules (SIM) cards 820, an application processor 806 coupled to a secure digital (SD) card 808 and a screen 810, a Bluetooth module 812, a wireless local area network (WLAN) module 814, a Global Positioning System (GPS) module 816, and a power supply 818. The cellular baseband processor 804 communicates through the cellular RF transceiver 822 with the UE 104 and/or BS 102/180. The cellular baseband processor 804 may include a computer-readable medium/memory. The computer-readable medium/memory may be non-transitory. The cellular baseband processor 804 is responsible for general processing, including the execution of software stored on the computer-readable medium/memory. The software, when executed by the cellular baseband processor 804, causes the cellular baseband processor 804 to perform the various functions described supra. The computer-readable medium/memory may also be used for storing data that is manipulated by the cellular baseband processor 804 when executing software. The cellular baseband processor 804 further includes a reception component 830, a communication manager 832, and a transmission component 834. The communication manager 832 includes the one or more illustrated components. The components within the communication manager 832 may be stored in the computer-readable medium/memory and/or configured as hardware within the cellular baseband processor 804. The cellular baseband processor 804 may be a component of the UE 104 and may include the memory 360 and/or at least one of the TX processor 368, the RX processor 356, and the controller/processor 359. In one configuration, the apparatus 802 may be a modem chip and include just the baseband processor 804, and in another configuration, the apparatus 802 may be the entire UE (e.g., see 104 of FIG. 3) and include the aforediscussed additional modules of the apparatus 802.

The communication manager 832 includes an obtaining component 840 that is configured to obtain, from a first network node, one or more parameters, wherein the first network node forms at least a portion of a serving cell to the apparatus; obtain, from the first network node, a layer-3 (L3) handover command; and obtain, from the first wireless node, a layer-1 (L1) or layer-2 (L2) handover command, e.g., as described in connection with 702, 708, and 710.

The communication manager 832 further includes a measuring component 842 configured to measure a wireless signal originated from a second network node, the measurement being based on the one or more parameters, wherein the second network node forms at least a portion of a first candidate serving cell to the apparatus, e.g., as described in connection with 704.

The communication manager 832 further includes an outputting component 844 configured to output, for transmission to the first network node, a measurement report based on the measurement of the wireless signal, e.g., as described in connection with 706.

The communication manager 832 further includes an executing component 846 configured to if the L1 or L2 handover command is obtained within the time window beginning upon obtaining the L3 command, execute the L1 or L2 handover command; if the L1 or L2 handover command is obtained outside the time window beginning upon obtaining the L3 command, execute the L3 handover command; if the priority command is the L1 or L2 handover command, execute the L1 or L2 handover command instead of the L3 command; if the priority command is the L3 handover command, execute the L3 handover command instead of the L1 or L2 command, e.g., as described in connection with 712, 714, 716, and 718.

The apparatus may include additional components that perform each of the blocks of the algorithm in the aforementioned flowchart of FIG. 7. As such, each block in the flowchart may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 802, and in particular the cellular baseband processor 804, includes means for obtaining, from a first network node, one or more parameters, wherein the first network node forms at least a portion of a serving cell to the apparatus; means for measuring a wireless signal originated from a second network node, the measurement being based on the one or more parameters, wherein the second network node forms at least a portion of a first candidate serving cell to the apparatus; means for outputting, for transmission to the first network node, a measurement report based on the measurement of the wireless signal; means for obtaining, from the first network node, a layer-3 (L3) handover command; means for obtaining, from the first wireless node, a layer-1 (L1) or layer-2 (L2) handover command; means for if the L1 or L2 handover command is obtained within the time window beginning upon obtaining the L3 command, executing the L1 or L2 handover command; means for if the L1 or L2 handover command is obtained outside the time window beginning upon obtaining the L3 command, executing the L3 handover command; means for if the priority command is the L1 or L2 handover command, executing the L1 or L2 handover command instead of the L3 command; means for if the priority command is the L3 handover command, executing the L3 handover command instead of the L1 or L2 command.

The aforementioned means may be one or more of the aforementioned components of the apparatus 802 configured to perform the functions recited by the aforementioned means. As described supra, the apparatus 802 may include the TX Processor 368, the RX Processor 356, and the controller/processor 359. As such, in one configuration, the aforementioned means may be the TX Processor 368, the RX Processor 356, and the controller/processor 359 configured to perform the functions recited by the aforementioned means.

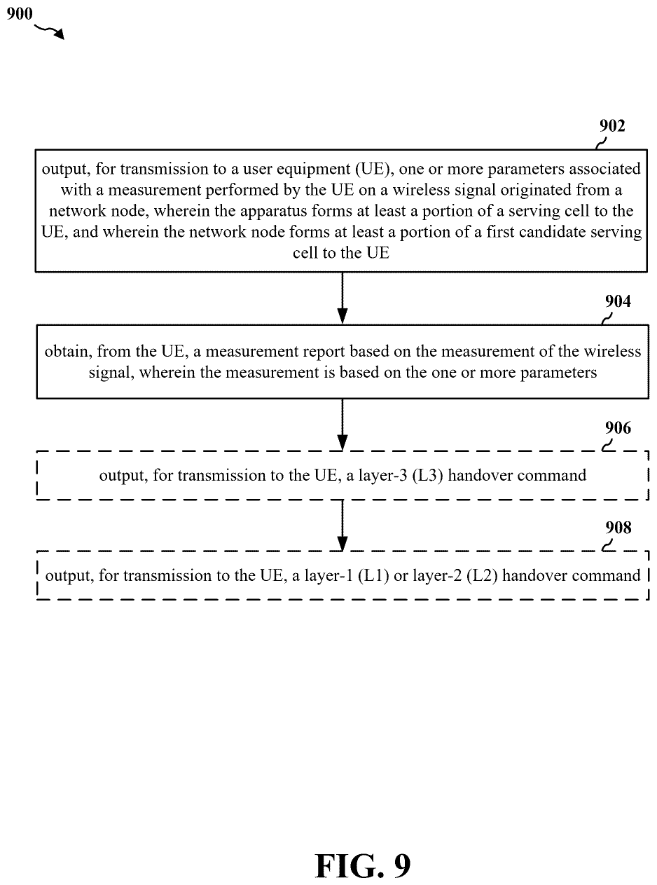

FIG. 9 is a flowchart 900 of a method of wireless communication. The method may be performed by a network node of a base station or the base station itself (e.g., the base station 102/180; the apparatus 1002). At 902, the base station may output, for transmission to a user equipment (UE), one or more parameters associated with a measurement performed by the UE on a wireless signal originated from a network node, wherein the apparatus forms at least a portion of a serving cell to the UE, and wherein the network node forms at least a portion of a first candidate serving cell to the UE. For example, 902 may be performed by an outputting component 1040.

At 904, the base station may obtain, from the UE, a measurement report indicating the measurement of the wireless signal, wherein the measurement is based on the one or more parameters. For example, 904 may be performed by an obtaining component 1042.

At 906, the base station may optionally output, for transmission to the UE, a layer-3 (L3) handover command. For example, 906 may be performed by the outputting component 1040.

Finally, at 908, the base station may optionally output, for transmission to the UE, a layer-1 (L1) or layer-2 (L2) handover command. For example, 908 may be performed by the outputting component 1040.

In certain aspects, the one or more parameters are output for transmission via at least one of a radio resource control (RRC) message, a medium access-control control element (MAC-CE), or a downlink control information (DCI) message.

In certain aspects, the one or more parameters indicate that the measurement is a layer-1 (L1) measurement or a layer-2 (L2) measurement, and wherein the one or more parameters comprise an indication to start or suspend the L1 or L2 measurement.

In certain aspects, the one or more parameters further comprise a threshold signal quality value and an indication for the UE to: start the L1 measurement or L2 measurement if the wireless signal obtained by the UE has less than the threshold signal quality value; and suspend the L1 measurement or L2 measurement if wireless signal obtained by the UE has greater than the threshold signal quality value.

In certain aspects, the one or more parameters further comprise an indication for the UE to: start the L1 measurement or L2 measurement if a timer expires prior to obtaining a handover command from the apparatus, the timer configured to begin upon output of the measurement report by the UE; and suspend the L1 measurement or L2 measurement if the UE obtains the handover command from the apparatus prior to expiration of the timer.

In certain aspects, the one or more parameters further comprise a duration of the timer.

In certain aspects, the one or more parameters comprise an indication for the UE to start or suspend the L1 measurement or L2 measurement according to a periodic schedule.

In certain aspects, the one or more parameters comprise an indication of a type of measurement of the wireless signal originated from the network node, and wherein the type of measurement comprises downlink synchronization, beam failure monitoring, radio link monitoring, channel state indication (CSI) measurement, tracking reference signal (TRS) measurement, or uplink timing measurement.

In certain aspects, the measurement report comprises an indication of: one or more types of measurement; or the first candidate serving cell.

In certain aspects, the one or more parameters comprise an indication of one or more candidate serving cells for the UE to generate the measurement report based on a corresponding wireless signal, the one or more candidate serving cells including the first candidate serving cell.

In certain aspects, the measurement is a layer-1 (L1) measurement, a layer-2 (L2) measurement, or a layer-3 (L3) measurement, and wherein the one or more parameters comprise an indication of whether one or more of the L1 measurement, the L2 measurement, and the L3 measurement are activated at the apparatus.

In certain aspects, an activation of the L1 measurement or L2 measurement deactivates the L3 measurement at the UE, and wherein an activation of the L3 measurement deactivates the L1 measurement or the L2 measurement at the UE.

In certain aspects, the one or more parameters further comprise an indication that if the L1 or L2 handover command is obtained by the UE within the time window beginning upon obtaining the L3 command, then the UE is to execute the L1 or L2 handover command, otherwise if the L1 or L2 handover command is obtained by the UE outside the time window beginning upon obtaining the L3 command, then the UE is to execute the L3 handover command.

In certain aspects, the one or more parameters further comprise an indication that if the priority command is the L1 or L2 handover command, then the UE is to execute the L1 or L2 handover command instead of the L3 command, and if the priority command is the L3 handover command, then the UE is to execute the L3 handover command instead of the L1 or L2 command.

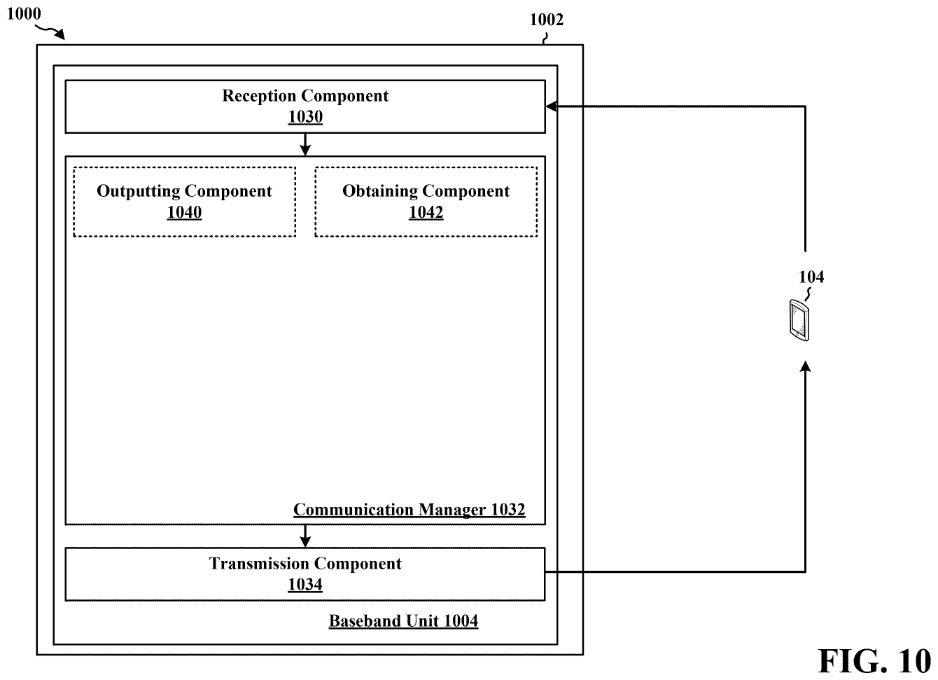

FIG. 10 is a diagram 1000 illustrating an example of a hardware implementation for an apparatus 1002. The apparatus 1002 is a BS and includes a baseband unit 1004. The baseband unit 1004 may communicate through a cellular RF transceiver with the UE 104. The baseband unit 1004 may include a computer-readable medium/memory. The baseband unit 1004 is responsible for general processing, including the execution of software stored on the computer-readable medium/memory. The software, when executed by the baseband unit 1004, causes the baseband unit 1004 to perform the various functions described supra. The computer-readable medium/memory may also be used for storing data that is manipulated by the baseband unit 1004 when executing software. The baseband unit 1004 further includes a reception component 1030, a communication manager 1032, and a transmission component 1034. The communication manager 1032 includes the one or more illustrated components. The components within the communication manager 1032 may be stored in the computer-readable medium/memory and/or configured as hardware within the baseband unit 1004. The baseband unit 1004 may be a component of the BS 102/180 and may include the memory 376 and/or at least one of the TX processor 316, the RX processor 370, and the controller/processor 375.

The communication manager 1032 includes an outputting component 1042 configured to output, for transmission to a user equipment (UE), one or more parameters associated with a measurement performed by the UE on a wireless signal originated from a network node, wherein the apparatus forms at least a portion of a serving cell to the UE, and wherein the network node forms at least a portion of a first candidate serving cell to the UE; output, for transmission to the UE, a layer-3 (L3) handover command; and output, for transmission to the UE, a layer-1 (L1) or layer-2 (L2) handover command, e.g., as described in connection with 902, 906, and 908.

The communication manager 1032 further includes an obtaining component 1042 configured to obtain, from the UE, a measurement report based on the measurement of the wireless signal, wherein the measurement is based on the one or more parameters, e.g., as described in connection with 904.

The apparatus may include additional components that perform each of the blocks of the algorithm in the aforementioned flowcharts of FIG. 9. As such, each block in the aforementioned flowchart of FIG. 9 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 1002, and in particular the baseband unit 1004, includes means for outputting, for transmission to a user equipment (UE), one or more parameters associated with a measurement performed by the UE on a wireless signal originated from a network node, wherein the apparatus forms at least a portion of a serving cell to the UE, and wherein the network node forms at least a portion of a first candidate serving cell to the UE; means for obtaining, from the UE, a measurement report based on the measurement of the wireless signal, wherein the measurement is based on the one or more parameters; means for outputting, for transmission to the UE, a layer-3 (L3) handover command; means for outputting, for transmission to the UE, a layer-1 (L1) or layer-2 (L2) handover command.

### Additional Considerations

The aforementioned means may be one or more of the aforementioned components of the apparatus 1002 configured to perform the functions recited by the aforementioned means. As described supra, the apparatus 1002 may include the TX Processor 316, the RX Processor 370, and the controller/processor 375. As such, in one configuration, the aforementioned means may be the TX Processor 316, the RX Processor 370, and the controller/processor 375 configured to perform the functions recited by the aforementioned means.

Means for receiving or means for obtaining may include a receiver (such as the receive processor 370) or an antenna(s) 320 of the BS 102 or the receive processor 3356 or antenna(s) 352 of the UE 104 illustrated in FIG. 3. Means for transmitting or means for outputting may include a transmitter (such as the transmit processor 316) or an antenna(s) 320 of the BS 102 or the transmit processor 368 or antenna(s) 352 of the UE 104 illustrated in FIG. 3. Means for executing and means for measuring may include a processing system, which may include one or more processors, such as the controller 340/380 of the BS 102 and the UE 104 illustrated in FIG. 3.

In some cases, rather than actually transmitting a frame a device may have an interface to output a frame for transmission (a means for outputting). For example, a processor may output a frame, via a bus interface, to a radio frequency (RF) front end for transmission. Similarly, rather than actually receiving a frame, a device may have an interface to obtain a frame received from another device (a means for obtaining). For example, a processor may obtain (or receive) a frame, via a bus interface, from an RF front end for reception.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

### Example Aspects

The following examples are illustrative only and may be combined with aspects of other embodiments or teachings described herein, without limitation.
Example 1 is a method for wireless communication at an apparatus, comprising: obtaining, from a first network node, one or more parameters, wherein the first network node forms at least a portion of a serving cell to the apparatus; measuring a wireless signal originated from a second network node, the measurement being based on the one or more parameters, wherein the second network node forms at least a portion of a first candidate serving cell to the apparatus; and outputting, for transmission to the first network node, a measurement report based on the measurement of the wireless signal.
Example 2 is the method of example 1, wherein the one or more parameters are obtained via at least one of a radio resource control (RRC) message, a medium access-control control element (MAC-CE), or a downlink control information (DCI) message.

Example 3 is the method of any of examples 1 and 2, wherein the measurement is a layer-1 (L1) measurement or a layer-2 (L2) measurement, and wherein the one or more parameters comprise an indication to start or suspend the L1 or L2 measurement.
Example 4 is the method of example 3, wherein the one or more parameters further comprise a threshold signal quality value and an indication to: start the L1 measurement or L2 measurement if signaling obtained from the first network node is less than the threshold signal quality value; and suspend the L1 measurement or L2 measurement if signaling obtained from the first network node is greater than the threshold signal quality value.
Example 5 is the method of example 3, wherein the one or more parameters further comprise an indication to: start the L1 measurement or L2 measurement if a timer expires prior to obtaining a handover command from the first network node, the timer configured to begin upon output of the measurement report; and suspend the L1 measurement or L2 measurement if the apparatus obtains the handover command from the first network node prior to expiration of the timer.
Example 6 is the method of example 5, wherein the one or more parameters further comprise a duration of the timer.
Example 7 is the method of example 3, wherein the one or more parameters comprise an indication to start or suspend the L1 measurement or L2 measurement according to a periodic schedule.
Example 8 is the method of any of examples 1-7, wherein the one or more parameters comprise an indication of a type of measurement of the wireless signal originated from the second network node, and wherein the type of measurement comprises downlink synchronization, beam failure monitoring, radio link monitoring, channel state indication (CSI) measurement, tracking reference signal (TRS) measurement, or uplink timing measurement.
Example 9 is the method of any of examples 1-8, wherein the measurement report comprises an indication of: one or more types of measurement; or the first candidate serving cell for which the measurement is performed.
Example 10 is the method of any of examples 1-9, wherein the one or more parameters comprise an indication of one or more candidate serving cells for which a measurement report is to be generated based on a corresponding wireless signal, the one or more candidate serving cells including the first candidate serving cell.
Example 11 is the method of any of examples 1-10, wherein the measurement is a layer-1 (L1) measurement, a layer-2 (L2) measurement, or a layer-3 (L3) measurement, and wherein the one or more parameters comprise an indication of whether one or more of the L1 measurement, the L2 measurement, and the L3 measurement are activated at the apparatus.
Example 12 is the method of example 11, wherein an activation of the L1 measurement or L2 measurement deactivates the L3 measurement, and wherein an activation of the L3 measurement deactivates the L1 measurement or the L2 measurement.
Example 13 is the method of any of examples 1-12, wherein the one or more parameters comprise an indication of a time window, and wherein the one or more processors are further configured to cause the apparatus to: obtain, from the first network node, a layer-3 (L3) handover command; obtain, from the first wireless node, a layer-1 (L1) or layer-2 (L2) handover command; if the L1 or L2 handover command is obtained within the time window beginning upon obtaining the L3 command, execute the L1 or L2 handover command; and if the L1 or L2 handover command is obtained outside the time window beginning upon obtaining the L3 command, execute the L3 handover command.
Example 14 is the method of any of claims 1-13, wherein the one or more parameters comprise an indication of a priority command, and wherein the one or more processors are further configured to cause the apparatus to: obtain, from the first network node, a layer-3 (L3) handover command; obtain, from the first wireless node, a layer-1 (L1) or layer-2 (L2) handover command; if the priority command is the L1 or L2 handover command, execute the L1 or L2 handover command instead of the L3 command; and if the priority command is the L3 handover command, execute the L3 handover command instead of the L1 or L2 command.
Example 15 is method for wireless communication at an apparatus, comprising: outputting, for transmission to a user equipment (UE), one or more parameters associated with a measurement performed by the UE on a wireless signal originated from a network node, wherein the apparatus forms at least a portion of a serving cell to the UE, and wherein the network node forms at least a portion of a first candidate serving cell to the UE; and obtaining, from the UE, a measurement report based on the measurement of the wireless signal, wherein the measurement is based on the one or more parameters.
Example 16 is the method of example 15, wherein the one or more parameters are output for transmission via at least one of a radio resource control (RRC) message, a medium access-control control element (MAC-CE), or a downlink control information (DCI) message.
Example 17 is the method of any of examples 15 and 16, wherein the one or more parameters indicate that the measurement is a layer-1 (L1) measurement or a layer-2 (L2) measurement, and wherein the one or more parameters comprise an indication to start or suspend the L1 or L2 measurement.
Example 18 is the method of example 17, wherein the one or more parameters further comprise a threshold signal quality value and an indication for the UE to: start the L1 measurement or L2 measurement if the wireless signal obtained by the UE has less than the threshold signal quality value; and suspend the L1 measurement or L2 measurement if wireless signal obtained by the UE has greater than the threshold signal quality value.
Example 19 is the method of example 17, wherein the one or more parameters further comprise an indication for the UE to: start the L1 measurement or L2 measurement if a timer expires prior to obtaining a handover command from the apparatus, the timer configured to begin upon output of the measurement report by the UE; and suspend the L1 measurement or L2 measurement if the UE obtains the handover command from the apparatus prior to expiration of the timer.
Example 20 is the method of example 19, wherein the one or more parameters further comprise a duration of the timer.
Example 21 is the method of example 17, wherein the one or more parameters comprise an indication for the UE to start or suspend the L1 measurement or L2 measurement according to a periodic schedule.
Example 22 is the method of any of examples 15-21, wherein the one or more parameters comprise an indication of a type of measurement of the wireless signal originated from the network node, and wherein the type of measurement comprises downlink synchronization, beam failure monitoring, radio link monitoring, channel state indication (CSI) measurement, tracking reference signal (TRS) measurement, or uplink timing measurement.
Example 23 is the method of example 22, wherein the measurement report comprises an indication of: one or more types of measurement; or the first candidate serving cell.
Example 24 is the method of example 22, wherein the one or more parameters comprise an indication of one or more candidate serving cells for the UE to generate the measurement report based on a corresponding wireless signal, the one or more candidate serving cells including the first candidate serving cell.
Example 25 is the method of any of examples 15-24, wherein the measurement is a layer-1 (L1) measurement, a layer-2 (L2) measurement, or a layer-3 (L3) measurement, and wherein the one or more parameters comprise an indication of whether one or more of the L1 measurement, the L2 measurement, and the L3 measurement are activated at the apparatus.
Example 26 is the method of example 25, wherein an activation of the L1 measurement or L2 measurement deactivates the L3 measurement at the UE, and wherein an activation of the L3 measurement deactivates the L1 measurement or the L2 measurement at the UE.
Example 27 is the method of any of examples 15-26, wherein the one or more parameters comprise an indication of a time window, and wherein the one or more processors are further configured to cause the apparatus to: output, for transmission to the UE, a layer-3 (L3) handover command; and output, for transmission to the UE, a layer-1 (L1) or layer-2 (L2) handover command, wherein the one or more parameters further comprise an indication that if the L1 or L2 handover command is obtained by the UE within the time window beginning upon obtaining the L3 command, then the UE is to execute the L1 or L2 handover command, otherwise if the L1 or L2 handover command is obtained by the UE outside the time window beginning upon obtaining the L3 command, then the UE is to execute the L3 handover command.
Example 28 is the method of any of examples 15-27, wherein the one or more parameters comprise an indication of a priority command, and wherein the one or more processors are further configure to cause the apparatus to: output, for transmission to the UE, a layer-3 (L3) handover command; and output, for transmission to the UE, a layer-1 (L1) or layer-2 (L2) handover command, wherein the one or more parameters further comprise an indication that if the priority command is the L1 or L2 handover command, then the UE is to execute the L1 or L2 handover command instead of the L3 command, and if the priority command is the L3 handover command, then the UE is to execute the L3 handover command instead of the L1 or L2 command.
Example 29 is a UE, comprising: a transceiver; a memory comprising instructions; and one or more processors configured to execute the instructions to cause the UE to perform a method in accordance with any one of examples 1-14, wherein the transceiver is configured to: receive the one or more parameters; and transmit the measurement report.
Example 30 is a network node, comprising: a transceiver; a memory comprising instructions; and one or more processors configured to execute the instructions and cause the network node to perform a method in accordance with any one of examples 15-28, wherein the transceiver is configured to: transmit the one or more parameters; and receive the measurement report.
Example 31 is an apparatus for wireless communications, comprising means for performing a method in accordance with any one of examples 1-14.
Example 32 is an apparatus for wireless communications, comprising means for performing a method in accordance with any one of examples 15-28.
Example 33 is a non-transitory computer-readable medium comprising instructions that, when executed by an apparatus, cause the apparatus to perform a method in accordance with any one of examples 1-14.
Example 34 is a non-transitory computer-readable medium comprising instructions that, when executed by an apparatus, cause the apparatus to perform a method in accordance with any one of examples 15-28.
Example 35 is an apparatus for wireless communications, comprising: a memory comprising instructions; and one or more processors configured to execute the instructions to cause the apparatus to perform a method in accordance with any one of examples 1-14.
Example 36 is an apparatus for wireless communications, comprising: a memory comprising instructions; and one or more processors configured to execute the instructions to cause the apparatus to perform a method in accordance with any one of examples 15-28.

1. An apparatus configured for wireless communication, comprising:
a memory comprising instructions; and
one or more processors configured to execute the instructions and cause the apparatus to:
obtain, from a first network node, one or more parameters, wherein the first network node forms at least a portion of a serving cell to the apparatus;
measure a wireless signal originated from a second network node, the measurement being based on the one or more parameters, wherein the second network node forms at least a portion of a first candidate serving cell to the apparatus; and
output, for transmission to the first network node, a measurement report based on the measurement of the wireless signal.

2. The apparatus of claim 1, wherein at least one of:
the one or more parameters are obtained via at least one of a radio resource control (RRC) message, a medium access-control control element (MAC-CE), or a downlink control information (DCI) message; or
the measurement is a layer-1 (L1) measurement or a layer-2 (L2) measurement, and wherein the one or more parameters comprise an indication to start or suspend the L1 or L2 measurement.

3. (canceled)

4. The apparatus of claim 2, wherein the one or more parameters further comprise a threshold signal quality value and an indication to:
start the L1 measurement or L2 measurement if signaling obtained from the first network node is less than the threshold signal quality value; and
suspend the L1 measurement or L2 measurement if signaling obtained from the first network node is greater than the threshold signal quality value.

5. The apparatus of claim 2, wherein the one or more parameters further comprise at least one of:
an indication to: start the L1 measurement or L2 measurement if a timer expires prior to obtaining a handover command from the first network node, the timer configured to begin upon output of the measurement report; and suspend the L1 measurement or L2 measurement if the apparatus obtains the handover command from the first network node prior to expiration of the timer; or
a duration of the timer.

6. (canceled)

7. The apparatus of claim 2, wherein the one or more parameters comprise an indication to start or suspend the L1 measurement or L2 measurement according to a periodic schedule.

8. The apparatus of claim 1, wherein the one or more parameters comprise an indication of a type of measurement of the wireless signal originated from the second network node, and wherein the type of measurement comprises downlink synchronization, beam failure monitoring, radio link monitoring, channel state indication (CSI) measurement, tracking reference signal (TRS) measurement, or uplink timing measurement.

9. The apparatus of claim 1, wherein the measurement report comprises an indication of:
one or more types of measurement; or
the first candidate serving cell for which the measurement is performed.

10. The apparatus of claim 1, wherein the one or more parameters comprise an indication of one or more candidate serving cells for which a measurement report is to be generated based on a corresponding wireless signal, the one or more candidate serving cells including the first candidate serving cell.

11. The apparatus of claim 1, wherein at least one of:
the measurement is a layer-1 (L1) measurement, a layer-2 (L2) measurement, or a layer-3 (L3) measurement, and wherein the one or more parameters comprise an indication of whether one or more of the L1 measurement, the L2 measurement, and the L3 measurement are activated at the apparatus; or
an activation of the L1 measurement or L2 measurement deactivates the L3 measurement, and wherein an activation of the L3 measurement deactivates the L1 measurement or the L2 measurement.

12. (canceled)

13. The apparatus of claim 1, wherein the one or more parameters comprise an indication of a time window, and wherein the one or more processors are further configured to cause the apparatus to:
obtain, from the first network node, a layer-3 (L3) handover command;
obtain, from the first wireless node, a layer-1 (L1) or layer-2 (L2) handover command;
if the L1 or L2 handover command is obtained within the time window beginning upon obtaining the L3 command, execute the L1 or L2 handover command; and
if the L1 or L2 handover command is obtained outside the time window beginning upon obtaining the L3 command, execute the L3 handover command.

14. The apparatus of claim 1, wherein the one or more parameters comprise an indication of a priority command, and wherein the one or more processors are further configured to cause the apparatus to:
obtain, from the first network node, a layer-3 (L3) handover command;
obtain, from the first wireless node, a layer-1 (L1) or layer-2 (L2) handover command;
if the priority command is the L1 or L2 handover command, execute the L1 or L2 handover command instead of the L3 command; and
if the priority command is the L3 handover command, execute the L3 handover command instead of the L1 or L2 command.

15. (canceled)

16. An apparatus configured for wireless communication, comprising:
a memory comprising instructions; and
one or more processors configured to execute the instructions and cause the apparatus to:
output, for transmission to a user equipment (UE), one or more parameters associated with a measurement performed by the UE on a wireless signal originated from a network node, wherein the apparatus forms at least a portion of a serving cell to the UE, and wherein the network node forms at least a portion of a first candidate serving cell to the UE; and
obtain, from the UE, a measurement report based on the measurement of the wireless signal, wherein the measurement is based on the one or more parameters.

17. The apparatus of claim 16, wherein at least one of:
the one or more parameters are output for transmission via at least one of a radio resource control (RRC) message, a medium access-control control element (MAC-CE), or a downlink control information (DCI) message; or
the one or more parameters indicate that the measurement is a layer-1 (L1) measurement or a layer-2 (L2) measurement, and wherein the one or more parameters comprise an indication to start or suspend the L1 or L2 measurement.

18. (canceled)

19. The apparatus of claim 17, wherein the one or more parameters further comprise a threshold signal quality value and an indication for the UE to:
start the L1 measurement or L2 measurement if the wireless signal obtained by the UE has less than the threshold signal quality value; and
suspend the L1 measurement or L2 measurement if wireless signal obtained by the UE has greater than the threshold signal quality value.

20. The apparatus of claim 17, wherein the one or more parameters further comprise at least one of:
an indication for the UE to start the L1 measurement or L2 measurement if a timer expires prior to obtaining a handover command from the apparatus, the timer configured to begin upon output of the measurement report by the UE and suspend the L1 measurement or L2 measurement if the UE obtains the handover command from the apparatus prior to expiration of the timer; or
a duration of the timer.

21. (canceled)

22. The apparatus of claim 17 , wherein the one or more parameters comprise an indication for the UE to start or suspend the L1 measurement or L2 measurement according to a periodic schedule.

23. The apparatus of claim 16, wherein at least one of:
the one or more parameters comprise an indication of a type of measurement of the wireless signal originated from the network node, and wherein the type of measurement comprises downlink synchronization, beam failure monitoring, radio link monitoring, channel state indication (CSI) measurement, tracking reference signal (TRS) measurement, or uplink timing measurement;
the measurement report comprises an indication of one or more types of measurement or the first candidate serving cell; or
the one or more parameters comprise an indication of one or more candidate serving cells for the UE to generate the measurement report based on a corresponding wireless signal, the one or more candidate serving cells including the first candidate serving cell.

24-25. (canceled)

26. The apparatus of claim 16, wherein at least one of:
the measurement is a layer-1 (L1) measurement, a layer-2 (L2) measurement, or a layer-3 (L3) measurement, and wherein the one or more parameters comprise an indication of whether one or more of the L1 measurement, the L2 measurement, and the L3 measurement are activated at the apparatus; or
an activation of the L1 measurement or L2 measurement deactivates the L3 measurement at the UE, and wherein an activation of the L3 measurement deactivates the L1 measurement or the L2 measurement at the UE.

27. (canceled)

28. The apparatus of claim 16, wherein the one or more parameters comprise an indication of a time window, and wherein the one or more processors are further configured to cause the apparatus to:
output, for transmission to the UE, a layer-3 (L3) handover command; and
output, for transmission to the UE, a layer-1 (L1) or layer-2 (L2) handover command, wherein the one or more parameters further comprise an indication that if the L1 or L2 handover command is obtained by the UE within the time window beginning upon obtaining the L3 command, then the UE is to execute the L1 or L2 handover command, otherwise if the L1 or L2 handover command is obtained by the UE outside the time window beginning upon obtaining the L3 command, then the UE is to execute the L3 handover command.

29. The apparatus of claim 16, wherein the one or more parameters comprise an indication of a priority command, and wherein the one or more processors are further configure to cause the apparatus to:
output, for transmission to the UE, a layer-3 (L3) handover command; and
output, for transmission to the UE, a layer-1 (L1) or layer-2 (L2) handover command, wherein the one or more parameters further comprise an indication that if the priority command is the L1 or L2 handover command, then the UE is to execute the L1 or L2 handover command instead of the L3 command, and if the priority command is the L3 handover command, then the UE is to execute the L3 handover command instead of the L1 or L2 command.

30. (canceled)
